(19) United States
(12) Patent Application Publication
(10) Pub. No.: US 2026/0328575 A1
(43) Pub. Date: Oct. 22, 2026

(54) INFORMATION PROCESSING METHOD AND DEVICE

(71) Applicant: Sony Semiconductor Solutions Corporation, Kanagawa (JP)

(72) Inventor: Masahiro MORITA, Kanagawa (JP)

(73) Assignee: Sony Semiconductor Solutions Corporation, Kanagawa (JP)

(21) Appl. No.: 19/646,578

(22) Filed: Apr. 14, 2026

(30) Foreign Application Priority Data
Apr. 21, 2025 (JP) 2025-069354

(51) Int. Cl. G01C 21/34; G01C 21/36

(52) U.S. Cl. CPC G01C 21/3453; G01C 21/3629

(57) ABSTRACT

Detecting an obstacle on a route along which a mobile object is movable, on the basis of movement route planning from a start point to an end point of movement of the mobile object; deriving a resolution cost required to resolve the detected obstacle; and searching for a route from the start point to the end point of the movement of the mobile object on the basis of the resolution cost and a movement cost related to the movement of the mobile object are executed. The present technology can be applied, for example, to an information processing device, an information processing method, or a program and the like.

### CROSS-REFERENCE TO RELATED APPLICATION

This application claims the benefit of Japanese Priority Patent Application JP 2025-069354 filed on Apr. 21, 2025, the entire contents of which are incorporated herein by reference.

### TECHNICAL FIELD

The present disclosure relates to an information processing method and device, and particularly to an information processing method and device capable of suppressing a reduction in reliability of route search.

### BACKGROUND ART

In the related art, for example, in systems such as driving assistance, automated driving control, vehicle dispatch, and conveyance, there has been a method of planning a movement route of a mobile object such as a vehicle and controlling the mobile object so as to move in accordance with the planned route. In such route planning, for example, a route that enables the mobile object to move to a destination at a lower cost has been searched on the basis of a movement cost of each edge in a map.

However, in practice, there have been cases in which an obstacle occurs on a route, causing a mobile object to be unable to pass along the planned route. Therefore, in a case where such an obstacle occurs, there has been a method of changing the route planning so as to avoid the obstacle. Furthermore, a method has also been considered in which a node arrangement is changed in accordance with occurrence of an obstacle such that the mobile object can pass (for example, see PTL 1).

### CITATION LIST

### Patent Literature

[PTL 1]

JP 2022-14996 A

### SUMMARY

### Technical Problem

However, as described above, even in a case where the route is changed or the node arrangement is changed, there may be cases in which the mobile object cannot move to a destination due to the obstacle. In such a case, a route is not able to be planned, and control of the mobile object may become difficult. Note that, for example, a method of issuing a warning in a case where an obstacle occurs may also be considered, but, with only such information, there is a risk that a cost required for a maintenance operator to resolve the obstacle unnecessarily increases, and a cost required to move the mobile object to the destination unnecessarily increases. That is, in the route search method in the related art, resolution of obstacles is not taken into consideration, and in an environment in which an obstacle may occur, there is a risk that reliability of route search decreases.

The present disclosure has been made in view of such circumstances and is intended to suppress a reduction in reliability of route search.

### Solution to Problem

An information processing method according to one aspect of the present technology is an information processing method including: detecting an obstacle on a route along which a mobile object is movable, on the basis of movement route planning from a start point to an end point of movement of the mobile object; deriving a resolution cost required to resolve the detected obstacle; and searching for a route from the start point to the end point of the movement of the mobile object on the basis of the resolution cost and a movement cost related to the movement of the mobile object.

An information processing device according to one aspect of the present technology is an information processing device including: an obstacle detection unit that detects an obstacle on a route along which a mobile object is movable, on the basis of movement route planning from a start point to an end point of movement of the mobile object; a resolution cost derivation unit that derives a resolution cost required to resolve the detected obstacle; and a route search unit that searches for a route from the start point to the end point of the movement of the mobile object on the basis of the resolution cost and a movement cost related to the movement of the mobile object.

In the information processing method and device according to one aspect of the present technology, processing including detecting an obstacle on a route along which a mobile object is movable, on the basis of movement route planning from a start point to an end point of movement of the mobile object; deriving a resolution cost required to resolve the detected obstacle; and searching for a route from the start point to the end point of the movement of the mobile object on the basis of the resolution cost and a movement cost related to the movement of the mobile object is executed.

### BRIEF DESCRIPTION OF DRAWINGS

FIG. 1 is a diagram illustrating an example of a map for route planning.

FIGS. 2A and 2B are a diagram illustrating an example of a state of route planning.

FIGS. 3A and 3B are a diagram illustrating an example of occurrence of an obstacle.

FIG. 4 is a diagram illustrating an example of route planning that takes obstacle resolution into consideration.

FIG. 5 is a block diagram illustrating a main configuration example of a route planning device.

FIG. 6 is a flowchart illustrating an example of a flow of route search processing.

FIG. 7 is a diagram illustrating an example of a state of setting a start point and an end point.

FIGS. 8A and 8B are a diagram illustrating an example of a state of obstacle detection and resolution cost derivation.

FIG. 9 is a diagram illustrating an example of a state of route planning that takes resolution cost into consideration.

FIGS. 10A and 10B are a diagram illustrating an example of a state of route planning that takes resolution cost into consideration.

FIG. 11 is a diagram illustrating an example of presentation of a search result.

FIG. 12 is a flowchart illustrating an example of a flow of route search processing.

FIG. 13 is a flowchart illustrating an example of a flow of route search processing.

FIG. 14 is a system diagram illustrating a main configuration example of a transportation system.

FIG. 15 is a block diagram illustrating a main configuration example of a management server.

### DESCRIPTION OF EMBODIMENTS

Hereinafter, embodiments for carrying out the present disclosure (hereinafter referred to as embodiments) will be described. Note that the description will be given in the following order.

1. Literature and the like supporting technical content and technical terms

2. Route planning

3. Route planning that takes resolution cost into consideration

4. First Embodiment (transportation System)
5. Supplementary notes

### <1. Literature and the Like Supporting Technical Content and Technical Terms

The scope disclosed in the present technology includes not only the content described in the embodiments but also content described in the following patent literature and the like that were publicly known at the time of filing, as well as content of other documents referenced in the following patent literature.

### PTL 1: (Described Above)

That is, content described in the above patent literature and content of other documents referenced in the above patent literature also serve as grounds for determining support requirements.

### <2. Route Planning

### Planning of Movement Route From Start Point to End Point

In the related art, for example, in systems such as driving assistance, automated driving control, vehicle dispatch, and conveyance, there has been a method of planning a movement route of a mobile object such as a vehicle and controlling the mobile object so as to move in accordance with the planned route. In such route planning, for example, a route that enables the mobile object to move to a destination at a lower cost has been searched on the basis of a movement cost of each edge in a map.

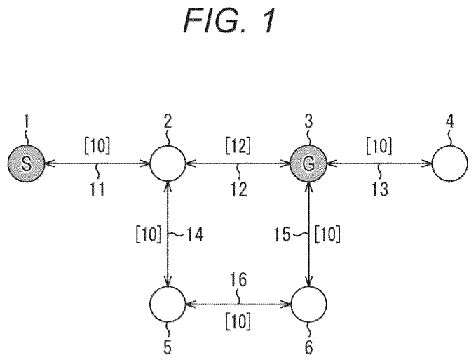

In such route planning, for example, a map including nodes and edges as illustrated in FIG. 1 has been used. This map is map information indicating routes along which a mobile object can move within a movement area in which the mobile object moves. A node indicates a predetermined position within the movement area, and an edge indicates a route between nodes. That is, in this map, routes along which the mobile object can move are schematically illustrated by the edges and the nodes. In the example of FIG. 1, the map has six nodes (nodes 1 to 6) and six edges (edges 11 to 16). A cost required for movement of the mobile object (also referred to as a movement cost in the present specification) is assigned to each edge. In the example of FIG. 1, the movement cost is indicated by a numerical value in brackets []. A larger numerical value indicates a larger movement cost, and a smaller numerical value indicates a smaller movement cost. For example, the edge 11 has a movement cost of [10], the edge 12 has a movement cost of [12], the edge 13 has a movement cost of [10], the edge 14 has a movement cost of [10], the edge 15 has a movement cost of [10], and the edge 16 has a movement cost of [10].

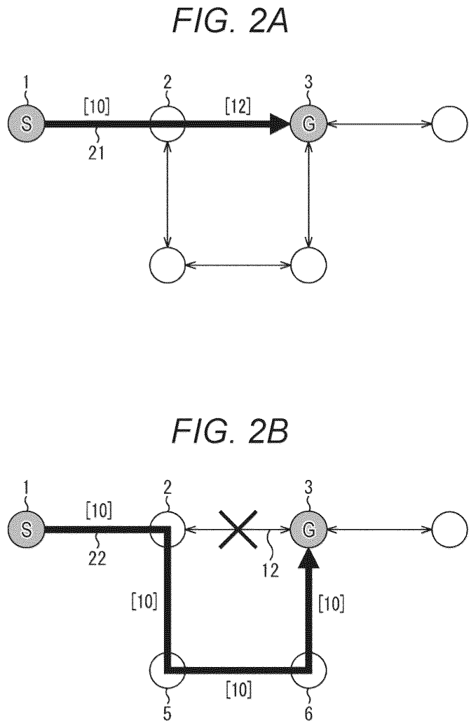

In such a map, a start point (the node 1 indicated by “S” in the drawing) and an end point (the node 3 indicated by “G” in the drawing) are set, and a movement route from the start point to the end point (which edges the mobile object passes through) is planned. In the present specification, the “start point” indicates a point at which movement of the mobile object is started, and the “end point” indicates a point at which movement of the mobile object is ended. At that time, a route that enables movement at a lower cost is searched on the basis of the above-described movement cost. In the example of FIG. 1, since a route passing through the edge 11 and the edge 12 has the lowest cost, the route is set as indicated by a thick arrow 21 illustrated in FIG. 2A.

### Countermeasures for Occurrence of Obstacle

However, in practice, there have been cases in which an obstacle occurs on a route, causing a mobile object to be unable to pass along the planned route. For example, when an obstacle occurs on the edge 12 illustrated in FIG. 2B (x mark), and the mobile object becomes unable to pass, the mobile object cannot be moved to a destination (end point) along the route indicated by the thick arrow 21 illustrated in FIG. 2A. In a case where such an obstacle occurs, there has been a method of changing route planning so as to avoid the obstacle. For example, as indicated by a thick arrow 22 illustrated in FIG. 2B, it can be considered to set a route that bypasses the impassable edge 12. Furthermore, for example, as described in PTL 1, a method has also been considered in which a node arrangement is changed in accordance with occurrence of an obstacle so that the mobile object can pass.

However, as described above, even in a case where the route is changed or the node arrangement is changed, there may be cases in which the mobile object cannot move to a destination due to the obstacle. For example, in the map of FIG. 1, in a case where obstacles occur on the edge 12 and the edge 14 and the mobile object becomes impassable on those edges, no route connecting the start point to the end point exists, and movement of the mobile object to the destination is not possible. In such a case, a route is not able to be planned, and control of the mobile object may become difficult.

Note that, for example, a method of issuing a warning in a case where an obstacle occurs may also be considered. However, with only such information, there is a risk that a cost required for a maintenance operator to resolve the obstacle unnecessarily increases, and a cost required for movement of the mobile object to the destination unnecessarily increases.

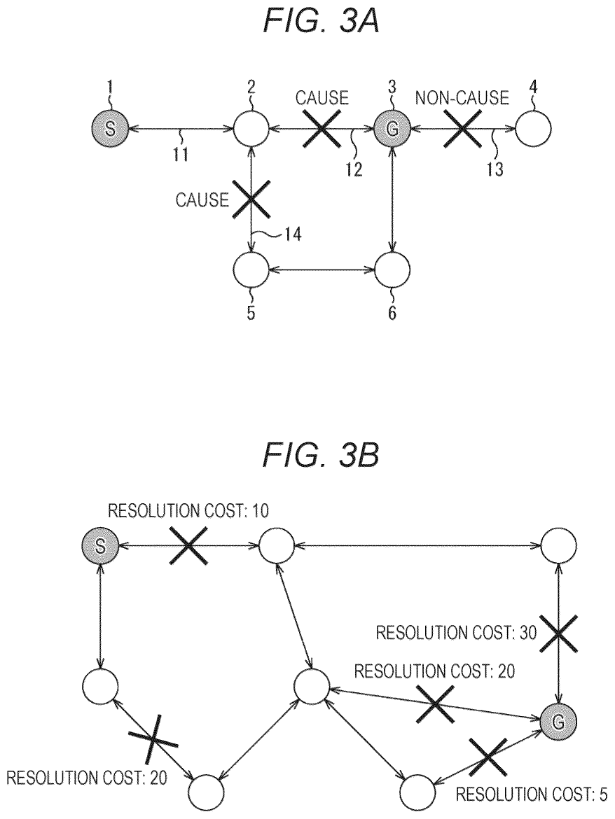

For example, as illustrated in FIG. 3A, in a case where obstacles occur on the edge 12, the edge 13, and the edge 14 and the mobile object becomes impassable, it is not obvious which obstacle causes a route to the destination to be unable to be established. In the example of FIG. 3A, obstacles on the edge 12 and the edge 14 are obstacles that cause the route to be unavailable, whereas an obstacle on the edge 13 does not constitute such a cause. Therefore, even if the obstacle on the edge 13 is resolved in this example, a route connecting the start point to the end point is not able to be established. That is, even in a case where the obstacle on the edge 13 is resolved, there is a risk that a cost for such work unnecessarily increases.

Furthermore, even in a case where two or more impassable edges that cause a route to be unavailable exist, it is not necessary to resolve all of those obstacles. In the example of FIG. 3A, by resolving an obstacle on either one of the edge 12 or the edge 14, a route connecting the start point to the end point for movement of the mobile object is able to be established. That is, even in a case where obstacles on both the edge 12 and the edge 14 are resolved, there is a risk that a cost for such work unnecessarily increases.

As described above, on the basis of warnings notifying that route planning has failed, warnings notifying occurrence of an obstacle, and the like, it has been difficult for a maintenance operator to ascertain which of these obstacles are resolved in order to move a mobile object to a destination at a lower cost. In other words, in the route search methods in the related art, resolution of obstacles is not taken into consideration, and in an environment in which an obstacle may occur, there is a risk that a cost for movement of the mobile object to the destination unnecessarily increases. That is, there is a risk that reliability of route search (that is, searching for a route that enables movement of a mobile object at a lower cost) decreases.

In practice, more diverse routes than in the example of FIG. 3A are able to be planned, and there may also be cases in which resolution of multiple obstacles is required. For example, in a case as illustrated in FIG. 3B, it is necessary to resolve multiple obstacles. Then, there are many combination patterns of obstacles that, when resolved, enable a route connecting the start point to the end point to be established. In addition, costs required to resolve respective obstacles (also referred to as resolution costs in the present specification) may not all be the same, as in the example of FIG. 3B.

In such a case, in order to move a mobile object to a destination at a lower cost, it is necessary to perform route planning in consideration of not only a movement cost of an edge but also a resolution cost (that is, to plan which edges are to be passed through and which obstacles are to be resolved). However, since such costs are not taken into consideration in the methods in the related art, there is a risk that a cost unnecessarily increases and reliability of route search decreases. For example, in a system that controls movement of a robot, when route planning fails due to an obstacle, the robot does not move and enters a stopped state, and there is a risk that the system substantially becomes nonfunctional. For example, in a transportation system that controls movement of a transport machine that transports packages in a logistics warehouse and the like, when route planning fails due to an obstacle and the transport machine stops, transportation efficiency decreases, and there is a risk that Return On Investment (ROI) deteriorates. Furthermore, there are cases in which picking has to be completed by a predetermined time for express delivery, and even a slight delay may lead to a critical result. Therefore, in general, in a case where movement of a mobile object to a destination is not possible, there are cases in which it is important to resolve such a problem more promptly.

### 3. Route Planning That Takes Resolution Cost Into Consideration

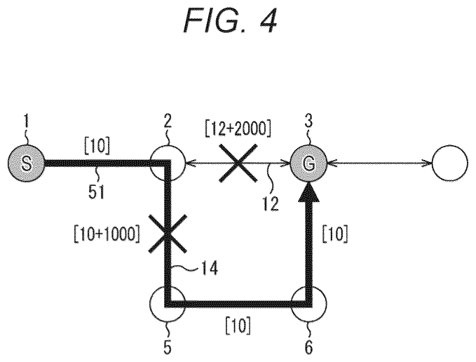

Accordingly, route search is performed so as to achieve a lower cost on the basis of a resolution cost and a movement cost. For example, as illustrated in FIG. 4, it is assumed that a resolution cost for the obstacle on the edge 12 is “2000” and a resolution cost for the obstacle on the edge 14 is “1000”. In a case of a route via the edge 12, a total cost is “10+12+2000=2022”, and in a case of a route indicated by a thick arrow 51 (route via the edge 14), a total cost is “10+10+1000+10+10=1040”. That is, the route indicated by the thick arrow 51 (route that passes by resolving the obstacle on the edge 14) enables movement of the mobile object at a lower cost. That is, by performing route search in this manner, even in an environment in which an obstacle may occur, it is possible to suppress a reduction in reliability of route search.

### Route Planning Device

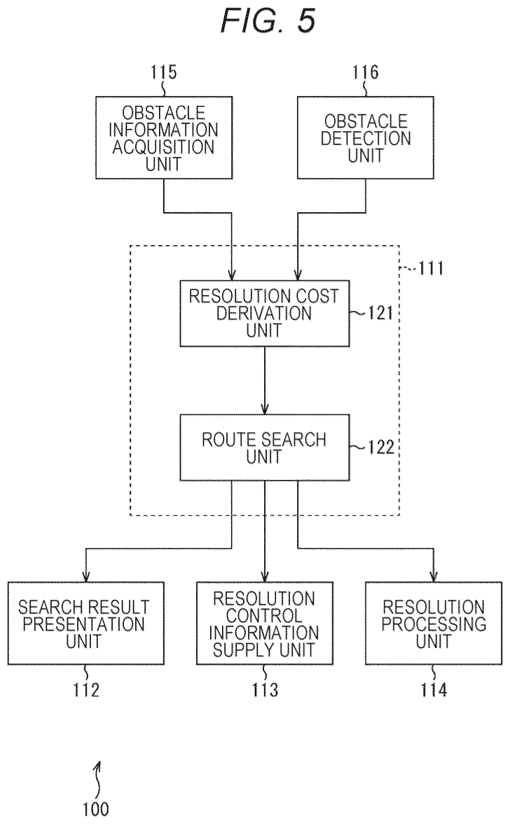

FIG. 5 is a diagram illustrating an example of a main configuration of a route planning device that is one embodiment of an information processing device to which the present technology is applied. A route planning device 100 illustrated in FIG. 5 is a device that plans a movement route from a start point to an end point for movement of a mobile object (not illustrated).

### Route Planning Unit

As illustrated in FIG. 5, the route planning device 100 (information processing device) has at least a route planning unit 111. The route planning unit 111 executes processing related to route planning of a mobile object. The route planning unit 111 applies the above-described present technology and performs route search so as to achieve a lower cost on the basis of a resolution cost and a movement cost. As illustrated in FIG. 5, the route planning unit 111 includes a resolution cost derivation unit 121 and a route search unit 122.

The resolution cost derivation unit 121 executes processing related to derivation of a resolution cost required to resolve an obstacle. For example, the resolution cost derivation unit 121 derives, on the basis of acquired obstacle information, a resolution cost required to resolve an obstacle detected on a route along which the mobile object is movable in planning of a movement route from a start point to an end point of movement of the mobile object. Furthermore, the resolution cost derivation unit 121 supplies the derived resolution cost (resolution cost for each obstacle) to the route search unit 122.

The route search unit 122 executes processing related to route search. For example, the route search unit 122 acquires a resolution cost supplied from the resolution cost derivation unit 121 and searches for a route from a start point to an end point of movement of the mobile object on the basis of the resolution cost and a movement cost related to the movement of the mobile object. For example, the route search unit 122 may search for a route that enables the mobile object to move from the start point to the end point at a lower cost.

Here, the “mobile object” may be any object as long as the object moves in accordance with route planning. For example, the mobile object may be a manned mobile object on which a driver rides, or may be an unmanned mobile object. Furthermore, movement of the “mobile object” may be controlled by a driver (operator), or may be controlled by a system and the like (that is, automated driving). For example, the “mobile object” may be a so-called drone. The movement area in which the “mobile object” moves may be any area, and may be, for example, on the ground, on water, underwater, or in the air. That is, the movement area may be a two-dimensional (planar) area or may be a three-dimensional (three-dimensional) area. That is, the map may be a two-dimensional map or may be a three-dimensional map. Furthermore, a movement method and a power source of the “mobile object” may be of any type. For example, energy may be supplied from outside. For example, the “mobile object” may be a vehicle, an N-legged walking robot (N is a natural number), a vessel, a submersible, or an aerial object. Note that, a purpose for which the “mobile object” moves may be any purpose. For example, the “mobile object” may be a transport machine that moves for a purpose of transporting a package or a person, or may be a non-transport machine that does not transport a package or a person.

Note that, in the present specification, “transport” means carrying people or packages, and is regarded as being synonymous with “carriage”, “freight transport”, “transportation”, “delivery”, and the like.

Furthermore, a “movement cost” indicates a cost required for movement and may include any concept as long as the concept is required for movement. For example, the “movement cost” may include time required for movement, difficulty of movement, and the like. Furthermore, the “movement cost (for each mobile object)” may be set in advance for each edge.

Furthermore, an “obstacle” may be any object as long as the object hinders movement of a mobile object. For example, obstacles related to the route, such as an obstacle object disposed on a route, a person standing still on a route, and a hole formed in a floor surface and the like of a route, are included in the “obstacle”. Furthermore, for example, an obstacle related to equipment, such as a failure of equipment disposed on a route may be included in the “obstacle”. Such equipment may include, for example, an elevator, a lift, a belt conveyor, a gate (automatic door), a sensor, a processing apparatus for a mobile object, or any other equipment as long as the equipment affects movement of the mobile object. Furthermore, for example, an obstacle related to the mobile object, such as a failure of the mobile object or depletion of a battery may be included. Furthermore, for example, a malfunction in which the mobile object approaches a wall surface or another mobile object too closely and becomes unable to move may be included in the “obstacle related to the mobile object”. In addition, any other obstacle, such as a poor physical condition of a driver or an operator, may be included in the “obstacle”.

Here, a “resolution cost” is a cost required to resolve an obstacle and may include any concept as long as the concept is required for resolution of the obstacle. For example, a resolution cost may include a parameter indicating time required for resolution. Furthermore, a resolution cost may include a parameter indicating labor required for resolution. Furthermore, a resolution cost may include a parameter indicating a budget required for resolution. Of course, a resolution cost may include a parameter indicating any other index than these.

With such a configuration, the route planning device 100 is able to perform route search so as to achieve a lower cost in consideration of not only a movement cost but also a resolution cost. Therefore, the route planning device 100 is able to suppress a reduction in reliability of route search even in an environment in which an obstacle may occur.

Note that, a method of route search performed by the route search unit 122 may be any method. For example, the route search unit 122 may search for a route from a start point to an end point of movement of a mobile object by using a weighting calculation of a resolution cost and a movement cost. For example, the weighting calculation may be a weighted sum (movement cost*w1+resolution cost*w2). Here, a weighting coefficient w1 is a coefficient indicating a weight of the movement cost, and a larger value indicates that the movement cost is given greater importance. Furthermore, a weighting coefficient w2 is a coefficient indicating a weight of the resolution cost, and a larger value indicates that the resolution cost is given greater importance. That is, respective values of the weighting coefficient w1 and the weighting coefficient w2 indicate which of the movement cost and the resolution cost is given greater importance. For example, in route search, in a case where the movement cost is given greater importance (in a case where it is desired to minimize the movement cost as much as possible), it is only required that a value of the weighting coefficient w1 is increased and a value of the weighting coefficient w2 is decreased. Conversely, in route search, in a case where the resolution cost is given greater importance (in a case where it is desired to minimize the resolution cost as much as possible), it is only required that a value of the weighting coefficient w2 is increased and a value of the weighting coefficient w1 is decreased. Note that, a sum of the weighting coefficient w1 and the weighting coefficient w2 may be a constant (for example, “1”).

By applying such weighting, the resolution cost and the movement cost can be compared with a desired balance to perform route search, thereby enabling more flexible route search in accordance with characteristics and conditions of a system.

### Presentation of Search Result

Furthermore, as illustrated in FIG. 5, the route planning device 100 may have a search result presentation unit 112. The search result presentation unit 112 performs processing related to presentation of a route search result. For example, the route search unit 122 may supply the route search result to the search result presentation unit 112. Then, the search result presentation unit 112 may acquire the search result. Furthermore, the search result presentation unit 112 may present the acquired search result. For example, the search result presentation unit 112 may present the search result by an image. For example, the search result presentation unit 112 may generate a presentation screen for presenting the acquired search result and cause the presentation screen to be displayed on a display unit (not illustrated). For example, the search result presentation unit 112 may display a presentation screen on a display unit included in the search result presentation unit 112 itself, or may supply the presentation screen to another device to cause the presentation screen to be displayed on a display unit included in the other device. Furthermore, the search result presentation unit 112 may present the search result by audio. Note that, a destination for presentation of the search result may be any target. For example, the search result may be presented to a system administrator (a device used by an administrator of a movement area in which a mobile object moves), the search result may be presented to a maintenance worker who maintains the system (a device used by a maintenance worker of the movement area in which the mobile object moves), or the search result may be presented to an operator who operates a transport machine.

By doing so, a user (for example, an administrator, a maintenance worker, a transport machine operator, or the like) to whom the search result is presented can more easily ascertain a route search result of the mobile object.

Note that, the search result may include any information. For example, the search result may include a map indicating a searched route. That is, the search result presentation unit 112 may generate a presentation screen including a map indicating the searched route and cause the presentation screen to be displayed on a display unit (not illustrated). By displaying the search result (route) on the map in this manner, a user (for example, an administrator, a maintenance worker, a transport machine operator, or r the like) to whom the search result is presented can more easily ascertain the searched route of the mobile object.

Furthermore, the map may include information indicating a location at which an obstacle has occurred. That is, the search result presentation unit 112 may generate a presentation screen including a map indicating the searched route and a location at which the detected obstacle has occurred, and cause the presentation screen to be displayed on a display unit (not illustrated). By displaying the search result (the route and the obstacle occurrence location) on a map in this manner, a user (for example, an administrator, a maintenance worker, a transport machine operator, or the like) to whom the search result is presented can more easily ascertain the searched route of the mobile object and the obstacle occurrence location.

Furthermore, in a case where an obstacle has occurred on the searched route, a resolution proposal for resolving the obstacle may be included in the search result. That is, in a case where an obstacle has occurred on the searched route, the search result presentation unit 112 may generate a presentation screen including a resolution proposal for resolving the obstacle and cause the presentation screen to be displayed on a display unit (not illustrated). By displaying the search result (resolution proposal) in this manner, a user (for example, an administrator, a maintenance worker, a transport machine operator, or the like) to whom the search result is presented can more easily resolve the obstacle on the basis of the resolution proposal.

The resolution proposal may include any information. For example, the resolution proposal may include information regarding the resolution cost. That is, the search result presentation unit 112 may generate a presentation screen including a resolution proposal that includes information regarding the resolution cost and cause the presentation screen to be displayed on a display unit (not illustrated). By displaying the search result (resolution proposal) in this manner, a user (for example, an administrator, a maintenance worker, a transport machine operator, or the like) to whom the search result is presented can more easily ascertain a resolution cost for a desired obstacle on the basis of the resolution proposal.

The information regarding the resolution cost may include any information. For example, the information regarding the resolution cost may include information indicating a work time required to resolve an obstacle. That is, the search result presentation unit 112 may generate a presentation screen including a resolution proposal that includes information regarding the resolution cost, including information indicating a work time required to resolve the obstacle, and cause the presentation screen to be displayed on a display unit (not illustrated). By displaying the search result (resolution proposal) in this manner, a user (for example, an administrator, a maintenance worker, a transport machine operator, or the like) to whom the search result is presented can more easily ascertain a work time required to resolve an obstacle on the basis of the resolution proposal.

Furthermore, the information regarding the resolution cost may include information indicating the number of workers required to resolve the obstacle or the number of robots required to resolve the obstacle. That is, the search result presentation unit 112 may generate a presentation screen including a resolution proposal that includes information regarding the resolution cost, including information indicating the number of workers and the number of robots required to resolve the obstacle, and cause the presentation screen to be displayed on a display unit (not illustrated). By displaying the search result (resolution proposal) in this manner, a user (for example, an administrator, a maintenance worker, a transport machine operator, or the like) to whom the search result is presented can more easily ascertain the number of workers and the number of robots required to resolve the obstacle on the basis of the resolution proposal.

Furthermore, the information regarding the resolution cost may include information indicating a cost required to resolve the obstacle. That is, the search result presentation unit 112 may generate a presentation screen including a resolution proposal that includes information regarding the resolution cost, including information indicating the cost required to resolve the obstacle, and cause the presentation screen to be displayed on a display unit (not illustrated). By displaying the search result (resolution proposal) in this manner, a user (for example, an administrator, a maintenance worker, a transport machine operator, or the like) to whom the search result is presented can more easily ascertain the cost required to resolve the obstacle on the basis of the resolution proposal.

Furthermore, the information regarding the resolution cost may include information indicating means required to resolve the obstacle. That is, the search result presentation unit 112 may generate a presentation screen including a resolution proposal that includes information regarding the resolution cost, including information indicating the means required to resolve the obstacle, and cause the presentation screen to be displayed on a display unit (not illustrated). For example, the “means required to resolve the obstacle” may include “tools required to resolve the obstacle”. These “tools” may be any tools that can be used to resolve the obstacle, and may include, for example, a spade, a shovel, a pickaxe, or a hammer. Furthermore, the “means required to resolve the obstacle” may include a “maintenance worker required to resolve the obstacle”. Furthermore, the “means required to resolve the obstacle” may include a “robot required to resolve the obstacle”. The “robot” may be any robot that can be used to resolve the obstacle, and may include, for example, a robot having a function of filling a hole or a robot having a function of removing an obstacle object. By displaying the search result (resolution proposal) in this manner, a user (for example, an administrator, a maintenance worker, a transport machine operator, or the like) to whom the search result is presented can more easily ascertain the means required to resolve the obstacle on the basis of the resolution proposal.

Furthermore, the resolution proposal may include information regarding a resolution method. That is, the search result presentation unit 112 may generate a presentation screen including a resolution proposal that includes information regarding the resolution method and cause the presentation screen to be displayed on a display unit (not illustrated). By displaying the search result (resolution proposal) in this manner, a user (for example, an administrator, a maintenance worker, a transport machine operator, or the like) to whom the search result is presented can more easily ascertain a resolution method for a desired obstacle on the basis of the resolution proposal.

Furthermore, the search result may include two or more searched routes and a resolution proposal for each of the two or more routes (for example, information regarding a resolution cost). That is, the search result presentation unit 112 may generate a presentation screen including the two or more searched routes and the resolution proposal for each of the two or more routes and cause the presentation screen to be displayed on a display unit (not illustrated). By displaying the search result (resolution proposals) in this manner, a user (for example, an administrator, a maintenance worker, a transport machine operator, or the like) to whom the search result is presented can more easily ascertain two or more routes and resolution proposals for obstacles that have occurred on each route.

In such a case, resolution proposals (for example, information regarding a resolution cost) for each route may be ranked in accordance with the resolution cost. That is, the search result presentation unit 112 may generate a presentation screen including the two or more searched routes and the resolution proposals for each of the two or more routes, the resolution proposals being ranked in accordance with the resolution cost, and cause the presentation screen to be displayed on a display unit (not illustrated). By displaying the search result (resolution proposals) in this manner, a user (for example, an administrator, a maintenance worker, a transport machine operator, or the like) to whom the search result is presented is able to ascertain resolution proposals for obstacles that have occurred on each of the two or more routes in ascending order (or descending order) of the resolution cost. Therefore, a priority order of the respective resolution proposals can be more easily determined.

### Supply of Resolution Control Information

Furthermore, as illustrated in FIG. 5, the route planning device 100 may have a resolution control information supply unit 113. The resolution control information supply unit 113 performs processing related to supply of resolution control information. Here, the “resolution control information” is control information regarding resolution of an obstacle that has occurred on a route. For example, the route search unit 122 may supply a route search result to the resolution control information supply unit 113. Then, the resolution control information supply unit 113 may acquire the search result. Furthermore, in a case where an obstacle has occurred on the searched route, on the basis of the acquired search result, the resolution control information supply unit 113 may generate resolution control information for resolving the obstacle and may supply the generated resolution control information. Note that, a supply destination of the resolution control information may be any destination. For example, the resolution control information supply unit 113 may supply the resolution control information to a resolution machine that is a device that performs work for resolving an obstacle. Furthermore, the resolution control information supply unit 113 may supply the resolution control information to a transport machine having a function of performing work for resolving an obstacle. Note that, the content of the resolution control information may be any content as long as the content is for controlling resolution of an obstacle.

By doing so, since work for resolving the detected obstacle can be controlled on the basis of the search result (obstacle detection result), the obstacle can be more easily resolved.

### Resolution of Obstacle

Furthermore, as illustrated in FIG. 5, the route planning device 100 may have a resolution processing unit 114. The resolution processing unit 114 performs processing related to work for resolving an obstacle. For example, the route search unit 122 may supply a route search result to the resolution processing unit 114. Then, the resolution processing unit 114 may acquire the search result. Furthermore, in a case where an obstacle has occurred on the searched route, the resolution processing unit 114 may execute work for resolving the obstacle on the basis of the acquired search result. That is, the route planning device 100 may have a function of resolving an obstacle and may execute work for resolving the obstacle on the basis of the route search result. Note that, work for resolving the obstacle may be any work.

By doing so, since work for resolving the detected obstacle can be executed on the basis of the search result (obstacle detection result), the obstacle can be more easily resolved.

### Derivation of Resolution Cost

Note that, the resolution cost derivation unit 121 may derive a resolution cost on the basis of information regarding the detected obstacle. By doing so, the resolution cost derivation unit 121 can more easily derive the resolution cost.

For example, the “information regarding the obstacle” may include information indicating a size of the obstacle. That is, the resolution cost derivation unit 121 may derive the resolution cost on the basis of information indicating the size of the detected obstacle. For example, a larger size of an obstacle object disposed on a route may correspond to a larger resolution cost. For example, a resolution cost for an obstacle object having a width of less than 1 m may be set to “1”, and a resolution cost for an obstacle object having a width of 1 m or more may be set to “2”. By doing so, the resolution cost derivation unit 121 can more easily derive a resolution cost in accordance with the size of the obstacle.

For example, the “information regarding the obstacle” may include information indicating the number of obstacles. That is, the resolution cost derivation unit 121 may derive the resolution cost on the basis of information indicating the number of detected obstacles. For example, a larger number of obstacle objects disposed on a route may correspond to a larger resolution cost. For example, a resolution cost for a single obstacle object may be set to “1”, and a resolution cost for multiple obstacle objects may be set to “2”. By doing so, the resolution cost derivation unit 121 can more easily derive a resolution cost in accordance with the number of obstacles.

For example, the “information regarding the obstacle” may include information indicating a type of the obstacle. That is, the resolution cost derivation unit 121 may derive the resolution cost on the basis of information indicating the type of the detected obstacle. For example, the resolution cost may be determined in accordance with what the obstacle is. For example, in a case where a cardboard box is disposed on a route as an obstacle object, a resolution cost thereof may be set to “1”, and in a case where a hole is formed in a floor surface of the route, a resolution cost thereof may be set to “100”. By doing so, the resolution cost derivation unit 121 can more easily derive a resolution cost in accordance with a type of the obstacle.

For example, the “information regarding the obstacle” may include information indicating a position of the obstacle. That is, the resolution cost derivation unit 121 may derive the resolution cost on the basis of information indicating the position of the detected obstacle. For example, the resolution cost may be set in accordance with a degree to which the obstacle interferes with movement of the mobile object. For example, a resolution cost for an obstacle object positioned at an edge of a route may be set to “1”, and a resolution cost for an obstacle object positioned at a center of the route may be set to “2”. By doing so, the resolution cost derivation unit 121 can more easily derive a resolution cost in accordance with the position of the obstacle.

Note that, the resolution cost derivation unit 121 may derive a resolution cost by comprehensively evaluating a plurality of items of the above-described “information regarding the obstacle”. For example, a resolution cost for an obstacle object that is a single (resolution cost “1”) cardboard box (resolution cost “1”) positioned at a center (resolution cost “2”) of a route, having a width of 1 m or more (resolution cost “2”) may be set to “2+2+1+1=6”. Note that, combination patterns of the items are arbitrary and are not limited to this example. Furthermore, the resolution cost derivation unit 121 may derive the resolution cost on the basis of a situation of maintenance workers. For example, the resolution cost may be derived in accordance with the number of maintenance workers capable of handling the obstacle. For example, as the number of maintenance workers capable of handling the obstacle increases, the resolution cost may be reduced. By doing so, the resolution cost derivation unit 121 can more easily derive a resolution cost in accordance with the situation of maintenance workers.

Furthermore, the resolution cost derivation unit 121 may derive a resolution cost on the basis of a situation of the mobile object. For example, the resolution cost may be derived in accordance with a size of the mobile object. For example, as the mobile object becomes larger, the resolution cost may be increased.

Furthermore, the resolution cost may be derived in accordance with whether the mobile object is in a movable state. By doing so, the resolution cost derivation unit 121 can more easily derive a resolution cost in accordance with the situation of the mobile object.

Furthermore, the resolution cost derivation unit 121 may derive the resolution cost on the basis of a situation of an obstacle occurrence location. For example, the resolution cost may be derived in accordance with a width of a route on which an obstacle has occurred. For example, even when an obstacle has occurred, if the width of the route is sufficiently large, a possibility that movement of the mobile object is not hindered becomes higher. In other words, it can be said that the obstacle is easy to resolve. Therefore, the resolution cost may be reduced as a width of the route becomes larger. For example, a resolution cost in a case where the width of the route is sufficiently large may be set to “0”, and a resolution cost in a case where the width of the route is not sufficiently large may be set to “1”. By doing so, the resolution cost derivation unit 121 can more easily derive a resolution cost in accordance with the situation of the obstacle occurrence location.

Note that, the resolution cost derivation unit 121 may derive the resolution cost by comprehensively evaluating the plurality of items described above. Note that, combination patterns of the items are arbitrary.

### Detection of Obstacle

Furthermore, as illustrated in FIG. 5, the route planning device 100 may have an obstacle information acquisition unit 115. The obstacle information acquisition unit 115 performs processing related to acquisition of obstacle information. For example, the obstacle information acquisition unit 115 may acquire obstacle information supplied from outside (another device and the like). Note that, the obstacle information is information regarding a detected obstacle. That is, the obstacle information includes information indicating where and what kind of obstacle has been detected. An external source (another device) that supplies the obstacle information may be any device. For example, the external source may be a sensor installed on a mobile object and configured to monitor surroundings of the mobile object, a sensor installed on a route and configured to monitor the route, or a sensor installed on equipment and configured to monitor a failure, an operating state, and the like of the equipment. Furthermore, a user may manually input the obstacle information. That is, the obstacle information may not be current (real-time) information (may be past information). Then, the obstacle information acquisition unit 115 may supply the acquired obstacle information to the resolution cost derivation unit 121. The resolution cost derivation unit 121 may acquire the obstacle information supplied from the obstacle information acquisition unit 115 and may derive a resolution cost required to resolve the obstacle indicated by the acquired obstacle information.

By doing so, a resolution cost for the detected obstacle can be more easily derived.

Furthermore, as illustrated in FIG. 5, the route planning device 100 may have an obstacle detection unit 116. The obstacle detection unit 116 performs processing related to detection of an obstacle. For example, the obstacle detection unit 116 may detect an obstacle on a route along which the mobile object is movable, on the basis of movement route planning from a start point to an end point of movement of the mobile object. For example, the obstacle detection unit 116 may be a sensor installed on the mobile object and configured to monitor surroundings of the mobile object, may be a sensor installed on a route and configured to monitor the route, or may be a sensor installed on equipment and configured to monitor a failure, an operating state, and the like of the equipment. Note that, the obstacle detection unit 116 may be any type of sensor. For example, the obstacle detection unit 116 may be an image sensor, an infrared sensor, a Lidar sensor, a radar sensor, or another sensor.

For example, the obstacle detection unit 116 may detect an obstacle object by image processing based on the video captured by a camera installed on a passage.

Furthermore, the obstacle detection unit 116 may detect placement of an obstacle object from a pressure sensor installed on a floor of a passage. Furthermore, the obstacle detection unit 116 may detect a failure of equipment such as an automatic door or an elevator through system linkage. Furthermore, an on-site operator may manually register, in the obstacle detection unit 116, an edge through which the mobile object is not passable. Furthermore, the obstacle detection unit 116 may detect an obstacle object by using sensors mounted on a robot, such as an RGB camera or a Lidar, when the robot passes through a passage. Furthermore, the obstacle detection unit 116 may acquire operation information of equipment, such as a forklift, that operates in the same work area as the robot.

The obstacle detection unit 116 may supply information regarding the detected obstacle to the resolution cost derivation unit 121. That is, the resolution cost derivation unit 121 may derive a resolution cost required to resolve an obstacle detected by the obstacle detection unit 116. By doing so, a resolution cost for the detected obstacle can be more easily derived.

### Flow 1 of Route Search Processing

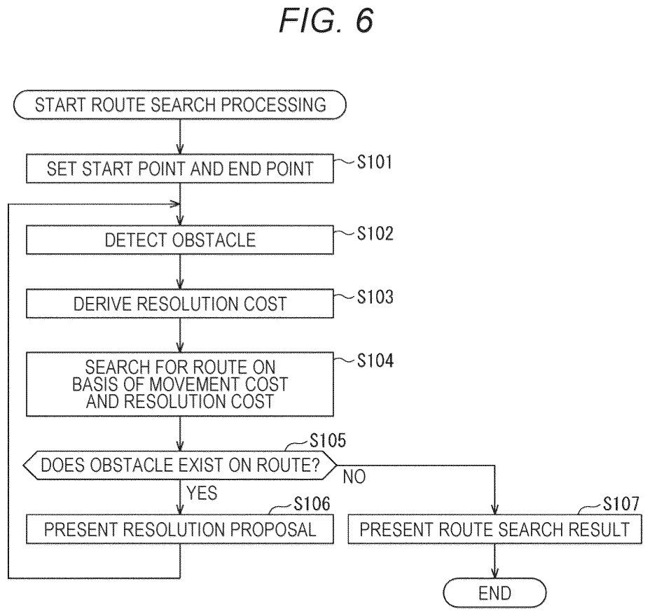

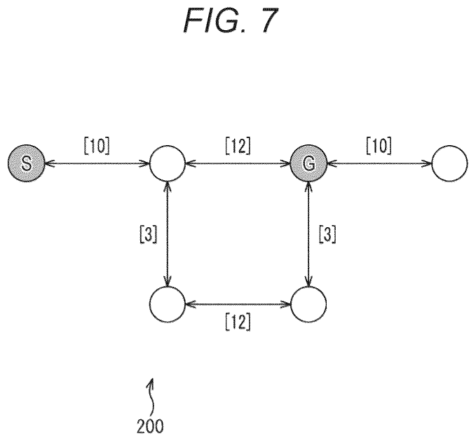

Next, an example of a flow of route search processing (information processing method, program) executed by the route planning device 100 will be described with reference to the flowchart of FIG. 6. As necessary, description will be given with reference to FIGS. 7 to 11.

When the route search processing is started, in step S101, the route search unit 122 sets a start point and an end point on a map. For example, as illustrated in FIG. 7, the route search unit 122 sets a start point(S) and an end point (G) at desired nodes on a map 200 corresponding to a movement area in which a mobile object moves. Note that, as illustrated in FIG. 7, a movement cost (a numerical value in brackets) of the mobile object is set in advance for each edge of the map 200.

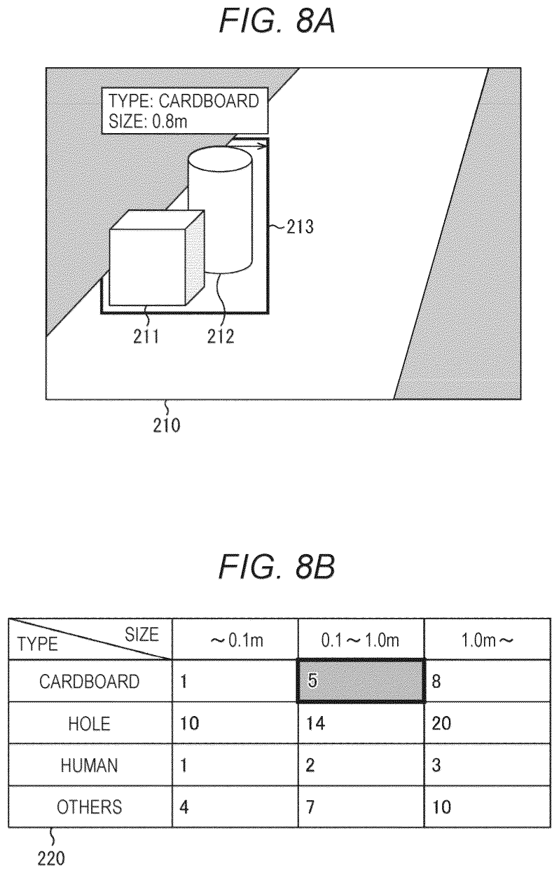

In step S102, the obstacle detection unit 116 detects an obstacle on a route along which the mobile object is movable, on the basis of movement route planning from the start point to the end point of movement of the mobile object. For example, the obstacle detection unit 116 performs an image analysis on a captured image 210 as illustrated in FIG. 8A, detects obstacle objects 211 and 212 disposed on a route, and sets a bounding box 213 that includes the obstacle objects. The obstacle detection unit 116 estimates, by the image analysis, that the obstacle objects 211 and 212 are cardboard boxes. Furthermore, the obstacle detection unit 116 estimates sizes of the obstacle objects 211 and 212 from a size of the bounding box 213 and the like. By doing so, a resolution cost for the detected obstacle can be more easily derived.

Note that, in step S102, instead of detecting an obstacle, obstacle information supplied from outside (another device and the like) may be acquired. By doing so, a resolution cost for the detected obstacle can be more easily derived.

In step S103, the resolution cost derivation unit 121 derives a resolution cost required to resolve the obstacle detected on the route along which the mobile object is movable in the movement route planning from the start point to the end point of the movement of the mobile object. Then, in step S104, the route search unit 122 searches for a route from the start point to the end point of the movement of the mobile object on the basis of the movement cost and the resolution cost.

By executing the processing in this manner, the route planning device 100 is able to perform route search so as to achieve a lower cost in consideration of not only the movement cost but also the resolution cost. Therefore, the route planning device 100 is able to suppress a reduction in reliability of route search even in an environment in which an obstacle may occur.

Note that, the resolution cost derivation unit 121 may derive a resolution cost on the basis of information regarding the detected obstacle. By doing so, the resolution cost derivation unit 121 can more easily derive the resolution cost. For example, the “information regarding the obstacle” may include information indicating a size of the obstacle. For example, a larger size of an obstacle object disposed on a route may correspond to a larger resolution cost. By doing so, the resolution cost derivation unit 121 can more easily derive a resolution cost in accordance with the size of the obstacle. For example, the “information regarding the obstacle” may include information indicating the number of obstacles. By doing so, the resolution cost derivation unit 121 can more easily derive a resolution cost in accordance with the number of obstacles. For example, the “information regarding the obstacle” may include information indicating a type of the obstacle. By doing so, the resolution cost derivation unit 121 can more easily derive a resolution cost in accordance with a type of the obstacle. For example, the “information regarding the obstacle” may include information indicating a position of the obstacle. By doing so, the resolution cost derivation unit 121 can more easily derive a resolution cost in accordance with the position of the obstacle.

Note that, the resolution cost derivation unit 121 may derive a resolution cost by comprehensively evaluating a plurality of items of the above-described “information regarding the obstacle”. Note that, combination patterns of the items are arbitrary.

Furthermore, the resolution cost derivation unit 121 may derive the resolution cost on the basis of a situation of maintenance workers. For example, the resolution cost may be derived in accordance with the number of maintenance workers capable of handling the obstacle. By doing so, the resolution cost derivation unit 121 can more easily derive a resolution cost in accordance with the situation of maintenance workers. Furthermore, the resolution cost derivation unit 121 may derive a resolution cost on the basis of a situation of the mobile object. By doing so, the resolution cost derivation unit 121 can more easily derive a resolution cost in accordance with the situation of the mobile object.

Furthermore, the resolution cost derivation unit 121 may derive the resolution cost on the basis of a situation of an obstacle occurrence location. By doing so, the resolution cost derivation unit 121 can more easily derive a resolution cost in accordance with the situation of the obstacle occurrence location.

Note that, the resolution cost derivation unit 121 may derive the resolution cost by comprehensively evaluating the plurality of items described above. Note that, combination patterns of the items are arbitrary.

For example, the resolution cost derivation unit 121 may have table information 220 as illustrated in FIG. 8B and may derive the resolution cost corresponding to the type and size of the obstacle objects 211 and 212 on the basis of the table information 220. In the example of FIG. 8A, since the obstacle object is a cardboard box having a width of 0.8 m, a resolution cost “5” is derived by using the table information 220. By using such table information, the resolution cost can be more easily derived.

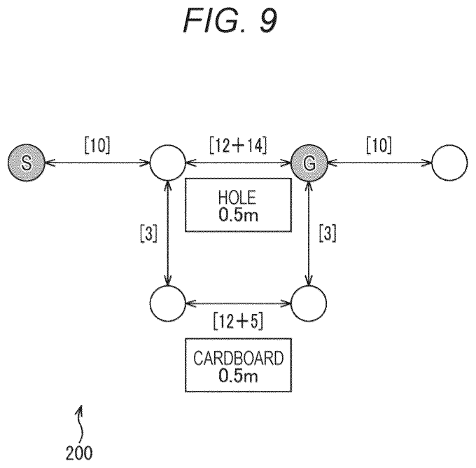

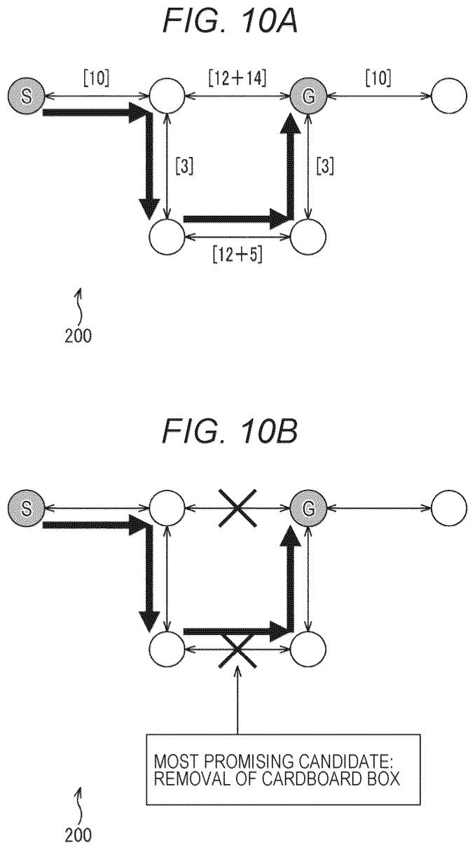

For example, as illustrated in FIG. 9, the route search unit 122 places the resolution cost derived as described above on the map 200 and adds the resolution cost to the movement cost. Then, the route search unit 122 searches for a route by using the map 200 to which the resolution cost has been added. For example, as illustrated in FIG. 10A, a route indicated by thick arrows is obtained as a search result. By doing so, the route search unit 122 can easily perform route search based on both the movement cost and the resolution cost.

Note that, a method of route search performed by the route search unit 122 may be any method. For example, the route search unit 122 may search for a route from a start point to an end point of movement of a mobile object by using a weighting calculation of a resolution cost and a movement cost. For example, the weighting calculation may be a weighted sum (movement cost*w1+resolution cost*w2). For example, in route search, in a case where the movement cost is given greater importance than the resolution cost (when it is desired to minimize the movement cost as much as possible), it is only required that a value of the weighting coefficient w1 is increased and a value of the weighting coefficient w2 is decreased. Conversely, in route search, in a case where the resolution cost is given greater importance than the movement cost (in a case where it is desired to minimize the resolution cost as much as possible (that is, in a case where it is desired to move the mobile object to a destination more quickly) ), it is only required that a value of the weighting coefficient w2 is increased and a value of the weighting coefficient w1 is decreased. Note that, a sum of the weighting coefficient w1 and the weighting coefficient w2 may be a constant (for example, “1”).

By applying such weighting, the resolution cost and the movement cost can be compared with a desired balance to perform route search, thereby enabling more flexible route search in accordance with characteristics and conditions of a system.

In step S105, the route search unit 122 determines whether an obstacle exists on the searched route. In a case where it is determined that an obstacle exists on the searched route, the processing proceeds to step S106. In step S106, the search result presentation unit 112 presents a resolution proposal. That is, in a case where an obstacle has occurred on the searched route, the presented search result may include a resolution proposal for resolving the obstacle. For example, as illustrated in FIG. 10B, it is indicated that removal of a cardboard box is required in order for the mobile object to move along the route indicated by thick arrows. By displaying the search result (resolution proposal) in this manner, a user (for example, an administrator, a maintenance worker, a transport machine operator, or the like) to whom the search result is presented can more easily resolve the obstacle on the basis of the resolution proposal.

Note that the presented resolution proposal may include any information. For example, the resolution proposal may include information regarding the resolution cost. By displaying the search result (resolution proposal) in this manner, a user (for example, an administrator, a maintenance worker, a transport machine operator, or the like) to whom the search result is presented can more easily ascertain a resolution cost for a desired obstacle on the basis of the resolution proposal. The information regarding the resolution cost may include any information. For example, the information regarding the resolution cost may include information indicating a work time required to resolve the obstacle. By displaying the search result (resolution proposal) in this manner, a user (for example, an administrator, a maintenance worker, a transport machine operator, or the like) to whom the search result is presented can more easily ascertain a work time required to resolve an obstacle on the basis of the resolution proposal. Furthermore, the information regarding the resolution cost may include information indicating the number of workers required to resolve the obstacle. By displaying the search result (resolution proposal) in this manner, a user (for example, an administrator, a maintenance worker, a transport machine operator, or the like) to whom the search result is presented can more easily ascertain the number of workers required to resolve the obstacle on the basis of the resolution proposal. Furthermore, the information regarding the resolution cost may include information indicating a cost required to resolve the obstacle. By displaying the search result (resolution proposal) in this manner, a user (for example, an administrator, a maintenance worker, a transport machine operator, or the like) to whom the search result is presented can more easily ascertain the cost required to resolve the obstacle on the basis of the resolution proposal. Furthermore, the information regarding the resolution cost may include information indicating means required to resolve the obstacle. For example, the means required to resolve the obstacle may include tools required to resolve the obstacle. Furthermore, the means required to resolve the obstacle may include a maintenance worker required to resolve the obstacle.

Furthermore, the means required to resolve the obstacle may include a robot required to resolve the obstacle. By displaying the search result (resolution proposal) in this manner, a user (for example, an administrator, a maintenance worker, a transport machine operator, or the like) to whom the search result is presented can more easily ascertain the means required to resolve the obstacle on the basis of the resolution proposal.

Furthermore, the presented resolution proposal may include information regarding a resolution method for the obstacle. By displaying the search result (resolution proposal) in this manner, a user (for example, an administrator, a maintenance worker, a transport machine operator, or the like) to whom the search result is presented can more easily ascertain a resolution method for the desired obstacle on the basis of the resolution proposal.

Furthermore, the presented search result may include a plurality of searched routes and a resolution proposal (for example, information regarding the resolution cost) for each of the plurality of routes. By displaying the search result (resolution proposals) in this manner, a user (for example, an administrator, a maintenance worker, a transport machine operator, or the like) to whom the search result is presented can more easily ascertain two or more routes and resolution proposals for obstacles that have occurred on each route. In that case, the resolution proposal (for example, information regarding the resolution cost) for each route may be ranked in accordance with the resolution cost. By displaying the search result (resolution proposals) in this manner, a user (for example, an administrator, a maintenance worker, a transport machine operator, or the like) to whom the search result is presented is able to ascertain resolution proposals for obstacles that have occurred on each of the two or more routes in ascending order (or descending order) of the resolution cost. Therefore, a priority order of the respective resolution proposals can be more easily determined.

When the processing of step S106 ends, the processing returns to step S102. While an obstacle occurs on the route, the processing from step S102 to step S106 is repeatedly executed. Then, in a case where it is determined in step S105 that no obstacle exists on the searched route, the processing proceeds to step S107. In step S107, the search result presentation unit 112 presents a route search result. For example, the search result presentation unit 112 may present the route search result by an image or by audio. For example, the search result presentation unit 112 may display a presentation screen on a display unit included in the search result presentation unit 112 itself, or may supply the presentation screen to another device to cause the presentation screen to be displayed on a display unit included in the other device. Note that, a destination for presentation of the search result may be any target. For example, the search result may be presented to a system administrator, the search result may be presented to a maintenance worker who maintains the system, or the search result may be presented to an operator who operates a transport machine. By doing so, a user (for example, an administrator, a maintenance worker, a transport machine operator, or the like) to whom the search result is presented can more easily ascertain a route search result of the mobile object. Note that, the search result may include any information. For example, the search result may include a map indicating a searched route. For example, a route search result (thick arrows) may be presented by using the map 200 as illustrated in FIG. 10A. By displaying the search result (route) on the map in this manner, a user (for example, an administrator, a maintenance worker, a transport machine operator, or the like) to whom the search result is presented can more easily ascertain the searched route of the mobile object. Furthermore, as in the example illustrated in FIG. 10B, the map 200 may include information (x mark) indicating an obstacle occurrence location. By displaying the search result (the route and the obstacle occurrence location) on a map in this manner, a user (for example, an administrator, a maintenance worker, a transport machine operator, or the like) to whom the search result is presented can more easily ascertain the searched route of the mobile object and the obstacle occurrence location.

When the processing of step S107 ends, the route search processing ends.

### Presentation Example

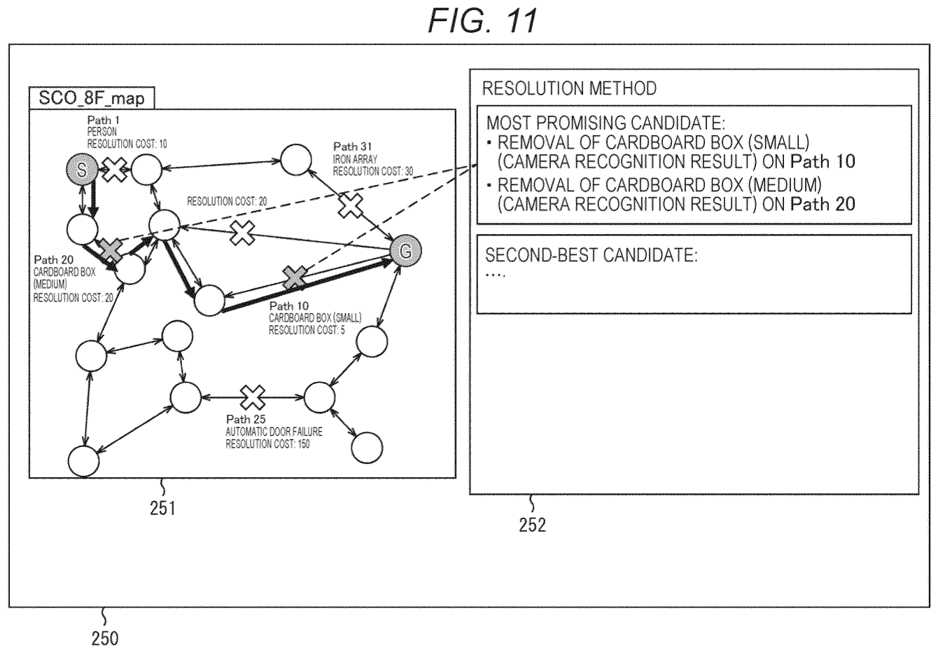

The search result may be presented, for example, on a presentation screen as illustrated in FIG. 11. A presentation screen 250 illustrated in FIG. 11 is a screen for presenting a search result, and includes a map display region 251 for displaying a map indicating a searched route and a resolution proposal display region 252 for displaying a resolution proposal for resolving an obstacle that has occurred on the route.

As illustrated in FIG. 11, in the map display region 251, the searched route (route along which the mobile object moves in a case where the obstacle is resolved) and information indicating a detected obstacle may be displayed. Furthermore, in the resolution proposal display region 252, a resolution proposal for resolving the obstacle is displayed for each route. In the resolution proposal display region 252, a resolution proposal for each of a plurality of routes can be displayed. That is, in the resolution proposal display region 252, a plurality of resolution proposals can be displayed. At that time, as illustrated in FIG. 11, each resolution proposal may be ranked and displayed on the basis of the resolution cost (most promising candidate, second-best candidate, and so on). Then, each resolution proposal may be displayed in association with the route indicated in the map display region 251.

By such presentation, the user can more easily ascertain a searched route, an obstacle to be resolved, a resolution method for the obstacle, and the like.

### Flow 2 of Route Search Processing

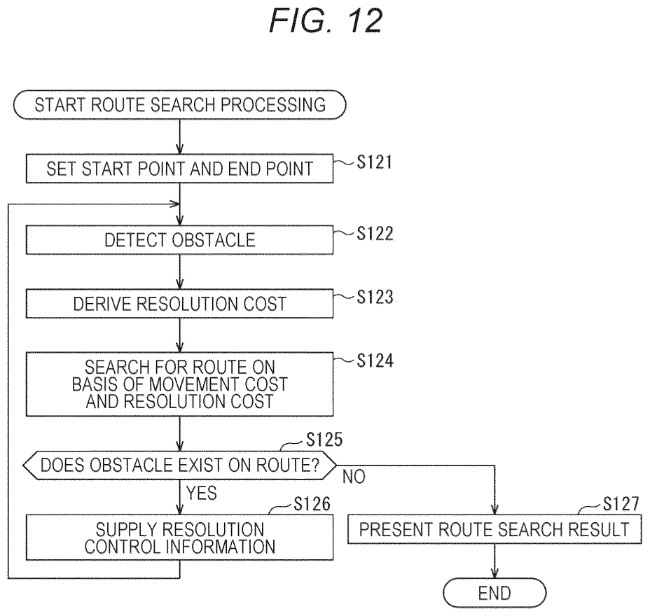

Next, with reference to the flowchart of FIG. 12, another example of a flow of the route search processing (information processing method, program) executed by the route planning device 100 will be described. When the route search processing is started, the processing of steps S121 to S125 is executed in the similar manner as the processing of steps S101 to S105 of FIG. 6.

In step S126, in a case where the obstacle has occurred on the searched route, on the basis of the search result, the resolution control information supply unit 113 generates and supplies resolution control information for resolving an obstacle. Note that, a supply destination of the resolution control information may be any destination. For example, the resolution control information may be supplied to a resolution machine as equipment that performs work for resolving the obstacle, or may be supplied to a transport machine having a function of performing work for resolving the obstacle. Note that, the content of the resolution control information may be any content as long as the content is for controlling resolution of an obstacle.

By doing so, since work for resolving the detected obstacle can be controlled on the basis of the search result (obstacle detection result), the obstacle can be more easily resolved.

When the processing of step S126 ends, the processing returns to step S122 . While an obstacle occurs on the route, the processing from step S122 to step S126 is repeatedly executed. Then, in a case where it is determined in step S125 that no obstacle exists on the searched route, the processing proceeds to step S127. The processing of step S127 is executed in the similar manner as the processing of step S107 of FIG. 6. When the processing of step S127 ends, the route search processing ends.

### Flow 3 of Route Search Processing

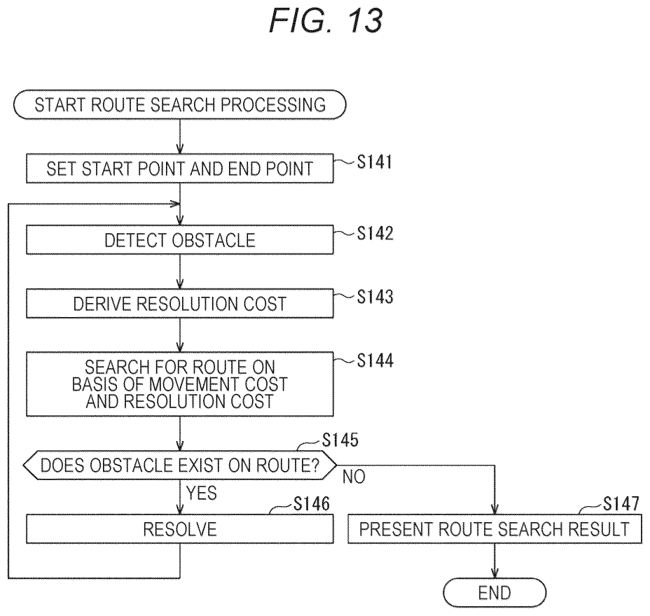

Next, with reference to the flowchart of FIG. 13, still another example of the flow of the route search processing (information processing method, program) executed by the route planning device 100 will be described.

When the route search processing is started, the processing of steps S141 to S145 is executed in the similar manner as the processing of steps S101 to S105 of FIG. 6.

In step S146, in a case where the obstacle has occurred on the searched route, on the basis of the search result, the resolution processing unit 114 executes work for resolving an obstacle. That is, the route planning device 100 has a function for resolving an obstacle and executes work for resolving the obstacle on the basis of the search result of the route. Note that, work for resolving the obstacle may be any work.

By doing so, since work for resolving the detected obstacle can be executed on the basis of the search result (obstacle detection result), the obstacle can be more easily resolved.

When the processing of step S146 ends, the processing returns to step S142. While an obstacle occurs on the route, the processing from step S142 to step S146 is repeatedly executed. Then, in a case where it is determined in step S145 that no obstacle exists on the searched route, the processing proceeds to step S147. The processing of step S147 is executed in the similar manner as the processing of step S107 of FIG. 6. When the processing of step S147 ends, the route search processing ends.

### 4. First Embodiment

### Transportation System

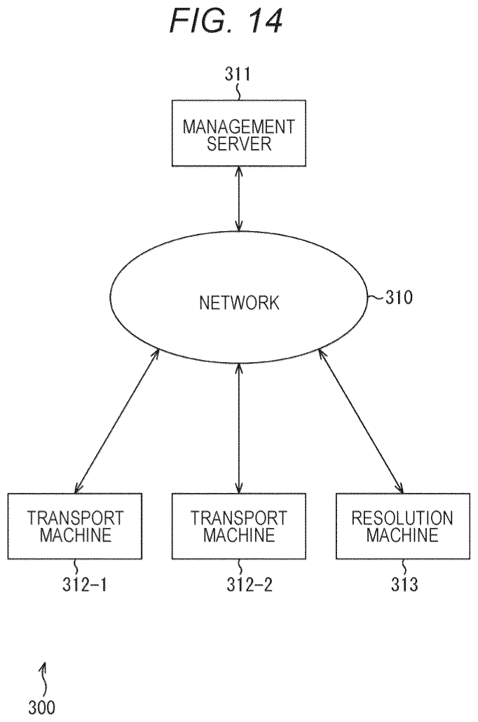

The present technology described above can be applied to any configuration (device, system, unit, processing unit, and the like). FIG. 14 illustrates an example of a main configuration of a transportation system that is an aspect of an information processing system to which the present technology is applied.

A transportation system 300 illustrated in FIG. 14 includes a management server 311, a transport machine 312-1, a transport machine 312-2, and a resolution machine 313, which are communicably connected to one another via a network 310. In a case where it is not necessary to distinguish between the transport machine 312-1 and the transport machine 312-2, the transport machine 312-1 and the transport machine 312-2 are collectively referred to as a transport machine 312. The transportation system 300 is a system that transports a package and the like by using the transport machine 312. That is, the transport machine 312 transports a package and the like, and the management server 311 manages the transport performed by the transport machine 312. Furthermore, in a case where an obstacle occurs, the resolution machine 313 performs work for resolving the obstacle. The management server 311 also manages behavior of the resolution machine 313.

In FIG. 14, two transport machines 312 (transport machine 312-1 and transport machine 312-2) are illustrated; however, the number of transport machines 312 included in the transportation system 300 is not limited, and may be one, or may be three or more. Furthermore, although one management server 311 is illustrated in FIG. 14, the number of management servers 311 included in the transportation system 300 is not limited, and may be two or more, for example. Furthermore, although one resolution machine 313 is illustrated in FIG. 14, the number of resolution machines 313 included in the transportation system 300 is not limited, and may be two or more, for example. Similarly, the transportation system 300 may include a plurality of networks 310. The network 310 is a communication network configured by any communication medium. Communication performed via the network 310 may be wired communication, wireless communication, or both. That is, the network 310 may be a communication network for wired communication, may be a communication network for wireless communication, or may be a communication network configured by both.

Furthermore, the network 310 may be configured by a single communication network or may be configured by a plurality of communication networks.

For example, the Internet may be included in the network 310. Furthermore, a public switched telephone network may be included in the network 310. Moreover, a wide-area communication network for wireless mobile objects, such as a so-called 3G line or 4G line, may be included in the network 310. For example, a Low Power Wide Area (LPWA) communication network such as LTE-M, which enables long-distance data communication and low power consumption, may be included in the network 310.

Furthermore, a Wide Area Network (WAN), a Local Area Network (LAN), and the like may be included in the network 310. Moreover, a wireless communication network that performs communication in conformity with the Bluetooth (registered trademark) standard may be included in the network 310. Furthermore, a communication path for short-range wireless communication such as Near Field Communication (NFC) may be included in the network 310. Moreover, a communication path for infrared communication may be included in the network 310. Furthermore, a communication network for wired communication in conformity with standards such as High-Definition Multimedia Interface (HDMI) (registered trademark) or Universal Serial Bus (USB) (registered trademark) may be included in the network 310. In this manner, the network 310 may include communication networks and communication paths of any communication standard. Note that the communication networks and communication paths may include not only communication media such as cables but also devices, circuits, and the like necessary for communication, such as communication devices and relay devices.

The management server 311, the transport machine 312, and the resolution machine 313 can communicate with other devices via the network 310 and exchange information. That is, the management server 311, the transport machine 312, and the resolution machine 313 may perform communication in conformity with any of the various communication standards described above. For example, the management server 311, the transport machine 312, and the resolution machine 313 may perform wired communication, may perform wireless communication, or may perform both.

### Management Server

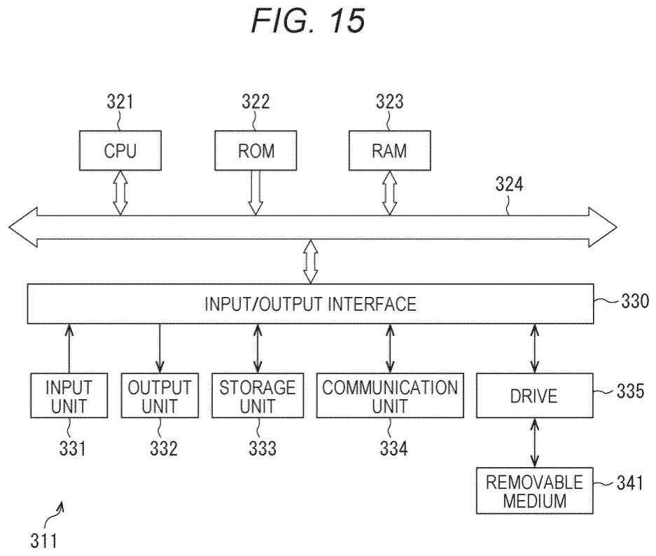

The management server 311 performs processing related to control of behavior of the transport machine 312 and the resolution machine 313. FIG. 15 is a block diagram illustrating a configuration example of hardware of the management server 311. As illustrated in FIG. 15, in the management server 311, a Central Processing Unit (CPU) 321, a Read Only Memory (ROM) 322, and a Random Access Memory (RAM) 323 are mutually connected via a bus 324. An input/output interface 330 is also connected to the bus 324. An input unit 331, an output unit 332, a storage unit 333, a communication unit 334, and a drive 335 are connected to the input/output interface 330. The input unit 331 includes, for example, a keyboard, a mouse, a microphone, a touch panel, input terminals, and the like. The output unit 332 includes, for example, a display, a speaker, output terminals, and the like. The storage unit 333 includes, for example, a hard disk, a RAM disk, a non-volatile memory, and the like. The communication unit 334 includes, for example, a network interface. The drive 335 drives a removable medium 341 such as a magnetic disk, an optical disk, a magneto-optical disk, or a semiconductor memory.

In the management server 311 configured as described above, the CPU 321 performs a series of processing by, for example, loading a program stored in the storage unit 333 into the RAM 323 via the input/output interface 330 and the bus 324 and executing the program. The RAM 323 also appropriately stores data required for the CPU 321 to execute various kinds of processing.

A program executed by the management server 311 can be applied by being recorded on the removable medium 341 such as a package medium. In that case, the program can be installed in the storage unit 333 via the input/output interface 330 by mounting the removable medium 341 on the drive 335.

Furthermore, the program can be provided via a wired or wireless transmission medium such as a local area network, the Internet, or digital satellite broadcasting. In that case, the program can be received by the communication unit 334 and installed in the storage unit 333.

Alternatively, the program can be installed in advance in the ROM 322 or the storage unit 333.

Note that the configuration illustrated in FIG. 15 described as the hardware configuration of the management server 311 is an example in which the management server 311 is configured by a single device. In practice, the functions of the management server 311 (that is, the configuration illustrated in FIG. 15) may be realized by a single device or may be realized by a plurality of devices. Furthermore, the management server 311 may be configured as a so-called cloud server.

Note that the transport machine 312 and the resolution machine 313 can also be said to have configurations similar to that of the management server 311. That is, the configurations of the transport machine 312 and the resolution machine 313 may also be described with reference to the block diagram of FIG. 15 (the block diagram of the management server 311).

### Application of Present Technology

In such a transportation system 300, the present technology described above in <3. Route planning that takes resolution cost into consideration> may be applied. That is, the functions of the route planning device 100 may be realized by using devices of the transportation system 300. For example, the configuration of the route planning device 100 described with reference to FIG. 5 and the processing described with reference to the flowchart of FIG. 6 may be realized in the management server 311, may be realized in the transport machine 312, or may be realized in the resolution machine 313.

Furthermore, the functions of the route planning device 100 may be realized by using a plurality of devices. For example, the route planning unit 111 may be provided in a first device, and other processing units may be provided in a second device. Furthermore, one processing unit may be realized by a plurality of devices.

For example, the functions of the route planning device 100 may be realized by combining a plurality of different types of devices, such as the management server 311 and the transport machine 312, the transport machine 312 and the resolution machine 313, the management server 311 and the resolution machine 313, or the management server 311, the transport machine 312, and the resolution machine 313. Furthermore, the functions of the route planning device 100 may be realized by combining a plurality of devices of the same type, such as a plurality of management servers 311, a plurality of transport machines 312, or a plurality of resolution machines 313. In addition, the functions of the route planning device 100 may be realized by any combination.

For example, in a case where the functions of the route planning device 100 are realized in the management server 311, the management server 311 may have the configuration (hardware) of the route planning device 100, or may realize the functions of the route planning device 100 by executing software. The same applies in a case where the functions are realized in the transport machine 312 or the resolution machine 313, or in a case where the functions are realized by combining a plurality of devices.

As described above, by applying the present technology described in <3. Route planning that takes resolution cost into consideration>, the transportation system 300 can suppress a reduction in reliability of route search of the transport machine 312.

### 5. Supplementary Notes

### Software

The series of processing described above can be executed by hardware or can be executed by software. In a case where the series of processing described above is executed by software, a program constituting the software is installed from a network or a recording medium.

The recording medium is, for example, as illustrated in FIG. 15, configured by the removable medium 341 on which the program is recorded and which is distributed to a user separately from the device main body in order to deliver the program to the user. The removable medium 341 includes a magnetic disk (including a flexible disk) and an optical disk (including a CD-ROM and a DVD). Moreover, a magneto-optical disk (including a Mini Disc (MD)), a semiconductor memory, and the like are also included. In this case, for example, by mounting the removable medium 341 on the drive 335, the program stored in the removable medium 341 can be read and installed in the storage unit 333.

Furthermore, the program can be provided via a wired or wireless transmission medium such as a local area network, the Internet, or digital satellite broadcasting. In that case, the program can be received by the communication unit 334 and installed in the storage unit 333.

Alternatively, the program may be installed in advance in a storage unit, a ROM, and the like. For example, the program may be installed in advance in the storage unit 333, the ROM 322, and the like.

### Applicable Targets of Present Technology

Furthermore, the present technology can be applied to any configuration. For example, the present technology can be applied to various electronic devices. Furthermore, the present technology can be applied not only to vehicles but also to automated driving control technology for any mobile object including, for example, ships and aircraft. The mobile object may be a manned vehicle in which a person rides, or may be an unmanned vehicle in which a person does not ride, such as a so-called drone. Furthermore, the present technology can be applied not only to automated driving control but also to any driving assistance technology including, for example, route guidance and driving operation assistance.

Furthermore, the present technology can be implemented as a partial configuration of a device, such as a processor (for example, a video processor) serving as a system Large Scale Integration (LSI) and the like, a module (for example, a video module) using a plurality of processors and the like, a unit (for example, a video unit) using a plurality of modules and the like, or a set (for example, a video set) in which additional functions are added to a unit.

Furthermore, the present technology can also be applied to a network system configured by a plurality of devices. For example, the present technology may be implemented as cloud computing in which processing is shared and cooperatively performed by a plurality of devices via a network. For example, the present technology may be implemented in a cloud service that provides services relating to images (moving images) to any terminals such as computers, Audio Visual (AV) devices, portable information processing terminals, and Internet of Things (IOT) devices.

Note that, in the present specification, a system means a collection of a plurality of components (devices, modules (parts), and the like), and whether all the components are contained within the same housing is not limited. Therefore, a plurality of devices housed in separate housings and connected via a network, and a single device in which a plurality of modules are housed within a single housing, both constitute a system.

### Field and Application to Which Present Technology is Applicable

A system, device, processing unit, and the like to which the present technology is applied can be used in any field such as traffic, medical care, crime prevention, agriculture, livestock farming, mining, beauty, factories, home appliances, weather, and natural environment monitoring. Furthermore, applications thereof may also be arbitrary.

For example, the present technology can be applied to a system or device used for providing viewing content and the like. Furthermore, for example, the present technology can be applied to a system or device used for traffic purposes such as traffic condition management and automated driving control. Moreover, for example, the present technology can be applied to a system or device used for security purposes. Furthermore, for example, the present technology can be applied to a system or device used for automatic control of machinery and the like. Moreover, for example, the present technology can be applied to a system or device used for agriculture or livestock farming. Furthermore, the present technology can be applied to a system or device that monitors natural conditions such as volcanoes, forests, and oceans, or wildlife. Moreover, for example, the present technology can be applied to a system or device used for sports.

### Others

Note that, in the present specification, terms such as “combine”, “multiplex”, “add”, “integrate”, “include”, “store”, “put in”, “embed”, “insert”, and the like mean combining a plurality of items into one, such as combining coded data and metadata into a single piece of data, and indicate one method of the above-described “association”.

Furthermore, the embodiments of the present technology are not limited to the above-described embodiments, and various modifications are possible without departing from the scope of the present technology.

For example, a configuration described as a single device (or processing unit) may be divided and configured as a plurality of devices (or processing units). Conversely, configurations described above as a plurality of devices (or processing units) may be combined and configured as a single device (or processing unit). Furthermore, it goes without saying that a configuration other than the above-described configurations may be added to the configuration of each device (or each processing unit). Moreover, if the configuration and operation of the system as a whole are substantially the same, a part of a configuration of a device (or processing unit) may be included in a configuration of another device (or another processing unit).

Furthermore, for example, the above-described programs may be executed in any device. In this case, it is only required that the device has the necessary functions (functional blocks and the like) and can obtain the necessary information.

Furthermore, for example, each step of one flowchart may be executed by a single device, or may be executed in a distributed manner by a plurality of devices. Moreover, in a case where one step includes a plurality of kinds of processing, the plurality of kinds of processing may be executed by a single device, or may be executed in a distributed manner by a plurality of devices. In other words, the plurality of kinds of processing included in one step may be executed as processing of a plurality of steps. Conversely, processing described as a plurality of steps may be combined and executed as a single step.

Furthermore, for example, a program executed by a computer may be configured such that processing of steps describing the program is executed in time sequence in accordance with the order described in the present specification, or may be executed in parallel or individually at necessary timing such as when a call is made. That is, as long as no inconsistency occurs, the processing of the respective steps may be executed in an order different from the order described above.

Moreover, the processing of the steps describing the program may be executed in parallel with processing of another program, or may be executed in combination with processing of another program.

Furthermore, for example, a plurality of technologies relating to the present technology may be implemented independently and individually as long as no inconsistency occurs. It goes without saying that any plurality of present technologies can be implemented in combination. For example, a part or all of the present technology described in any embodiment can be implemented in combination with a part or all of the present technology described in another embodiment. Furthermore, a part of all of any of the present technologies described above can be implemented together with another technology that is not described above.

Note that the present technology can also have the following configurations.

(1) An information processing method including:

detecting an obstacle on a route along which a mobile object is movable, on the basis of movement route planning from a start point to an end point of movement of the mobile object;

deriving a resolution cost required to resolve the detected obstacle; and

searching for a route from the start point to the end point of the movement of the mobile object on the basis of the resolution cost and a movement cost related to the movement of the mobile object.

(2) The information processing method according to (1), including:

searching for the route from the start point to the end point of the movement of the mobile object by using a weighting calculation of the resolution cost and the movement cost.

(3) The information processing method according to (1) or (2), further including:

presenting a search result of the route.

(4) The information processing method according to (3), in which

the search result of the route is presented by an image.

(5) The information processing method according to (3) or (4), in which

the search result of the route is presented by audio.

(6) The information processing method according to any one of (3) to (5), in which

the search result includes a map indicating the searched route.

(7) The information processing method according to (6), in which

the map includes information indicating an occurrence location of the obstacle.

(8) The information processing method according to any one of (3) to (7), in which

the search result includes information regarding a resolution cost for resolving the obstacle in a case where the obstacle has occurred on the searched route.

(9) The information processing method according to (8), in which

the information regarding the resolution cost includes information indicating a work time required for resolving the obstacle.

(10) The information processing method according to (8) or (9), in which

the information regarding the resolution cost includes information indicating the number of workers required for resolving the obstacle or the number of robots required for resolving the obstacle.

(11) The information processing method according to any one of (8) to (10), in which

the information regarding the resolution cost includes information indicating a cost required for resolving the obstacle.

(12) The information processing method according to any one of (8) to (11), in which

the information regarding the resolution cost includes information indicating means required for resolving the obstacle.

(13) The information processing method according to (12), in which

the means required for resolving the obstacle includes a tool required for resolving the obstacle.

(14) The information processing method according to (12) or (13), in which

the means required for resolving the obstacle includes a maintenance worker required for resolving the obstacle.

(15) The information processing method according to any one of (12) to (14), in which

the means required for resolving the obstacle includes a robot required for resolving the obstacle.

(16) The information processing method according to any one of (8) to (15), in which

the search result includes a plurality of searched routes and information regarding the resolution cost for each of the plurality of routes.

(17) The information processing method according to (16), in which

the information regarding the resolution cost for each route is ranked in accordance with the resolution cost.

(18) The information processing method according to any one of (1) to (17), further including:

supplying resolution control information for resolving the obstacle in a case where the obstacle has occurred on the searched route.

(19) The information processing method according to any one of (1) to (18), further including:

executing processing for resolving the obstacle in a case where the obstacle has occurred on the searched route.

(20) A program for causing a computer to execute processing including:

detecting an obstacle on a route along which a mobile object is movable, on the basis of movement route planning from a start point to an end point of movement of the mobile object;

deriving a resolution cost required to resolve the detected obstacle; and

searching for a route from the start point to the end point of the movement of the mobile object on the basis of the resolution cost and a movement cost related to the movement of the mobile object.

(21) An information processing device including:

an obstacle detection unit that detects an obstacle on a route along which a mobile object is movable, on the basis of movement route planning from a start point to an end point of movement of the mobile object;

a resolution cost derivation unit that derives a resolution cost required to resolve the detected obstacle; and

a route search unit that searches for a route from the start point to the end point of the movement of the mobile object on the basis of the resolution cost and a movement cost related to the movement of the mobile object.

### REFERENCE SIGNS LIST

100 Route planning device
111 Route planning unit
112 Search result presentation unit
113 Resolution control information supply unit
114 Resolution processing unit
115 Obstacle information acquisition unit
116 Obstacle detection unit
121 Resolution cost derivation unit
122 Route search unit
300 Transportation system
310 Network
311 Management server
312 Transport machine
313 Resolution machine

1. An information processing method comprising:
detecting an obstacle on a route along which a mobile object is movable, on a basis of movement route planning from a start point to an end point of movement of the mobile object;
deriving a resolution cost required to resolve the detected obstacle; and
searching for a route from the start point to the end point of the movement of the mobile object on a basis of the resolution cost and a movement cost related to the movement of the mobile object.

2. The information processing method according to claim 1, comprising:
searching for the route from the start point to the end point of the movement of the mobile object by using a weighting calculation of the resolution cost and the movement cost.

3. The information processing method according to claim 1, further comprising:
presenting a search result of the route.

4. The information processing method according to claim 3, wherein
the search result of the route is presented by an image.

5. The information processing method according to claim 3, wherein
the search result of the route is presented by audio.

6. The information processing method according to claim 3, wherein
the search result includes a map indicating the searched route.

7. The information processing method according to claim 6, wherein
the map includes information indicating an occurrence location of the obstacle.

8. The information processing method according to claim 3, wherein
the search result includes information regarding a resolution cost for resolving the obstacle in a case where the obstacle has occurred on the searched route.

9. The information processing method according to claim 8, wherein
the information regarding the resolution cost includes information indicating a work time required for resolving the obstacle.

10. The information processing method according to claim 8, wherein
the information regarding the resolution cost includes information indicating a number of workers required for resolving the obstacle or a number of robots required for resolving the obstacle.

11. The information processing method according to claim 8, wherein
the information regarding the resolution cost includes information indicating a cost required for resolving the obstacle.

12. The information processing method according to claim 8, wherein
the information regarding the resolution cost includes information indicating means required for resolving the obstacle.

13. The information processing method according to claim 12, wherein
the means required for resolving the obstacle includes a tool required for resolving the obstacle.

14. The information processing method according to claim 12, wherein
the means required for resolving the obstacle includes a maintenance worker required for resolving the obstacle.

15. The information processing method according to claim 12, wherein
the means required for resolving the obstacle includes a robot required for resolving the obstacle.

16. The information processing method according to claim 8, wherein
the search result includes a plurality of searched routes and information regarding the resolution cost for each of the plurality of routes.

17. The information processing method according to claim 16, wherein
the information regarding the resolution cost for each route is ranked in accordance with the resolution cost.

18. The information processing method according to claim 1, further comprising:
supplying resolution control information for resolving the obstacle in a case where the obstacle has occurred on the searched route.

19. The information processing method according to claim 1, further comprising:
executing processing for resolving the obstacle in a case where the obstacle has occurred on the searched route.

20. An information processing device comprising:
an obstacle detection unit that detects an obstacle on a route along which a mobile object is movable, on a basis of movement route planning from a start point to an end point of movement of the mobile object;
a resolution cost derivation unit that derives a resolution cost required to resolve the detected obstacle; and
a route search unit that searches for a route from the start point to the end point of the movement of the mobile object on a basis of the resolution cost and a movement cost related to the movement of the mobile object.
